(19) United States
(12) Patent Application Publication
(10) Pub. No.: US 2026/0094617 A1
(43) Pub. Date: Apr. 2, 2026

(54) METHOD OF PROCESSING MULTIMEDIA, ELECTRONIC DEVICE, AND STORAGE MEDIUM

(71) Applicant: Beijing Zitiao Network Technology Co., Ltd., Beijing (CN)

(72) Inventors: Dufeiyang XU, Beijing (CN); Yuqiao MIAO, Beijing (CN); Yongpan SONG, Beijing (CN)

(21) Appl. No.: 19/327,911

(22) Filed: Sep. 12, 2025

(30) Foreign Application Priority Data
Sep. 30, 2024 (CN) 202411388736.0

(51) Int. Cl. G11B 27/031; G11B 27/34; G11B 27/36

(52) U.S. Cl. CPC G11B 27/031; G11B 27/34; G11B 27/36

(57) ABSTRACT

Embodiments of the present disclosure relate to a method of processing multimedia, an electronic device, and a storage medium, the method includes: determining a target global timestamp corresponding to a target frame to be rendered in a target draft; the target draft includes a first material and editing information corresponding to the first material, the target draft is nested with a first sub-draft, and the first sub-draft includes a second material and editing information corresponding to the second material; obtaining a target time mapping relationship between the target draft and the second material when the target global timestamp is located in a time interval corresponding to the first sub-draft in the target draft, and determining a material timestamp corresponding to the target global timestamp in the second material; determining a target material frame based on the material timestamp, and rendering the target frame based on the target material frame.

### CROSS-REFERENCE TO RELATED APPLICATION(S)

The present application claims priority to Chinese Patent Application No. 202411388736.0, filed on Sep. 30, 2024, which is incorporated herein by reference in its entirety as a part of the present application.

### TECHNICAL FIELD

The present disclosure relates to the technical field of multimedia editing, and more particularly, to a method of processing multimedia, electronic device, and storage medium.

### BACKGROUND

Existing multimedia editors provide users with tremendous video editing convenience. The multimedia editor is able to create a video editing project (draft for short) for the user, the draft contains the track set by the user and the material placed on the track, and finally, the material on the track may be superimposed to output the video. The inventors have found that existing drafts already support sub-draft nesting functionality, i.e. one draft (sub-draft) may be added as material to any position in another draft (parent draft). However, in the related art, a rendering method for a draft nesting case is not good, and there are problems such as waste of resources, therefore, there is still a need for improvement.

### SUMMARY

Embodiments of the present disclosure provide a method of processing multimedia, the method including: determining a target global timestamp corresponding to a target frame to be rendered in a target draft, where the target draft includes a first material and editing information corresponding to the first material, and the target draft is nested with a first sub-draft, and the first sub-draft includes a second material and editing information corresponding to the second material, the target frame is used for displaying an editing effect image of the target draft at the target global timestamp; obtaining a target time mapping relationship between the target draft and the second material when the target global timestamp is located in a time interval corresponding to the first sub-draft in the target draft, and determining a material timestamp corresponding to the target global timestamp in the second material according to the target global timestamp and the target time mapping relationship, where the target time mapping relationship is used for representing a mapping relationship between a timeline corresponding to the target draft and a timeline corresponding to the second material; determining a target material frame from the second material based on the material timestamp, and rendering the target frame based on the target material frame.

Optionally, the obtaining a target time mapping relationship between the target draft and the second material includes: obtaining a first time mapping relationship, where the first time mapping relationship is used for representing a mapping relationship between the timeline corresponding to the target draft and a timeline corresponding to the first sub-draft; obtaining a second time mapping relationship, where the second time mapping relationship is used for representing a mapping relationship between the timeline corresponding to the first sub-draft and the timeline corresponding to a second material in the first sub-draft; obtaining a target time mapping relationship between the target draft and the second material based on the first time mapping relationship and the second time mapping relationship.

Optionally, the method further includes: obtaining and saving a mapping relationship between the timeline corresponding to the target draft and a timeline corresponding to each layer of sub-draft in the target draft when the target draft includes a plurality of layers of sub-draft that are nested, where a mapping relationship between the timeline corresponding to the target draft and a timeline corresponding to a second sub-draft in the plurality of layers sub-draft is determined based on a mapping relationship between the timeline corresponding to the target draft and a timeline corresponding to a parent draft of the second sub-draft and a mapping relationship between the timeline corresponding to the parent draft of the second sub-draft and the timeline corresponding to the second sub-draft, where the target draft and the second sub-draft are in an indirect nesting relationship.

Optionally, the method further includes: determining a playback state of the second material based on a material timestamp corresponding to the target global timestamp in the second material and a material timestamp corresponding to a material frame located before the target material frame in the second material, where the playback state includes one or more of a forward playback state, a reverse playback state, a slow-forward state, and a fast-forward state.

Optionally, before rendering the target frame based on the target material frame, the method further includes: querying a frame drop table, where a frame drop moment in the target draft is recorded in the frame drop table; and dropping the target frame when the frame drop table indicates that the target global timestamp belongs to the frame drop moment.

Optionally, the frame drop moment is recorded in a frame drop table by: determining the frame drop moment in the target draft in response to detecting that the target draft has an audio-video desynchronization problem when the target draft is currently in a playback state; and recording the frame drop moment in the frame drop table.

Optionally, the method further includes: determining that the audio-video desynchronization problem occurs in the target draft when detecting that a global timestamp of a currently played audio is greater than a specified global timestamp, where the specified global timestamp is equal to the sum of a global timestamp of a frame to be presented for which rendering is completed and a single frame duration of the frame to be presented.

Optionally, the determining the frame drop moment in the target draft includes: taking a global timestamp of a frame currently starting to be rendered as a frame drop start moment; taking a minimum value between the global timestamp of a currently played audio and an end timestamp of the currently played audio as a frame drop end moment; and determining the frame drop moment in the target draft based on a moment between the frame drop start moment and the frame drop end moment.

Optionally, the determining the frame drop moment in the target draft based on a moment between the frame drop start moment and the frame drop end moment includes: determining a moment between the frame drop start moment and the frame drop end moment as a frame drop moment; or, extracting an exempt frame from the moment between the frame drop start moment and the frame drop end moment according to a preset interval, and determining the moment other than the exempt frame from the moment between the frame drop start moment and the frame drop end moment as the frame drop moment.

Embodiments of the present disclosure also provide a multimedia processing apparatus including: a global timestamp determination module configured to determine a target global timestamp corresponding to a target frame to be rendered in a target draft, where the target draft includes at least one track and material on the track, and the target draft is nested with a first sub-draft, and the first sub-draft serves as a material clip on a target track in the at least one track; a material timestamp determination module configured to obtain, when the target frame corresponds to the first sub-draft, a target time mapping function between the target draft and the target frame, and to determine a material timestamp corresponding to the target frame according to the target global timestamp and the target time mapping function, where the target time mapping function is used for representing a mapping relationship between a global time corresponding to the target draft and a material time of a target material corresponding to the target frame; and a frame rendering module configured to render the target frame based on the target material and a material timestamp corresponding to the target frame.

Embodiments of the present disclosure also provide an electronic device including: at least one processor; and a memory for storing the processor-executable instructions; the at least one processor is configured to read the executable instructions from the memory and execute the instructions to implement a method of processing multimedia as provided by an embodiment of the present disclosure.

Embodiments of the present disclosure also provide a computer-readable storage medium storing a computer program for executing the method of processing multimedia as provided by the embodiments of the present disclosure.

It is to be understood that the description in this section is not intended to identify key or critical features of the embodiments of the disclosure, nor is it intended to limit the scope of the disclosure. Other features of the present disclosure will become readily apparent from the following description.

### BRIEF DESCRIPTION OF DRAWINGS

The accompanying drawings, which are incorporated in and constitute a part of this specification, illustrate embodiments consistent with the disclosure and, together with the description, serve to explain the principles of the disclosure.

In order to explain the embodiments of the present disclosure or the technical solutions in the prior art more clearly, the following brief introduction will be made to the drawings used in the description of the embodiments or the prior art, and it would have been obvious for a person of ordinary skill in the art to obtain other drawings according to these drawings without involving any inventive effort.

FIG. 1 is a schematic diagram of rendering of a related art provided by an embodiment of the present disclosure;

FIG. 2 is a schematic diagram of a time mapping principle of a driver provided by an embodiment of the present disclosure;

FIG. 3 is a schematic diagram of the flow of a method of processing multimedia provided by an embodiment of the present disclosure;

FIG. 4 is a schematic diagram of rendering provided by an embodiment of the present disclosure;

FIG. 5 is a schematic diagram of rendering provided by an embodiment of the present disclosure;

FIG. 6 is a schematic diagram of a time mapping principle of a driver provided by an embodiment of the present disclosure;

FIG. 7 is a schematic structure diagram of a multimedia processing apparatus provided by an embodiment of the present disclosure; and

FIG. 8 is a schematic structure diagram of an electronic device provided by an embodiment of the present disclosure.

### DETAILED DESCRIPTION

In order that the foregoing objects, features, and advantages of the disclosure may be more clearly understood, a more particular description of the disclosure will be rendered by reference to embodiments thereof which are illustrated in the appended drawings. It should be noted that the embodiments and features of the embodiments of the present disclosure may be combined with each other without conflict.

In the following description, numerous specific details are set forth in order to provide a thorough understanding of the present disclosure, but the present disclosure may be practiced otherwise than as described herein; It is to be understood that the embodiments in the description are only a part of the embodiments of the present disclosure, not all of them.

In the draft nesting scenario, the sub-draft may be added as material to any track in the parent draft, and secondary processing may be performed on the whole sub-draft in the parent draft, such as cutting, speed changing, and so on. In addition, multi-layer draft nesting may also be realized, i.e. sub-drafts may also nest other drafts as track materials of sub-drafts. Each draft needs to support opening and editing separately, and in each sub-draft, only the attributes of each material in this draft are usually saved, while the information of the parent draft is usually not saved. Whether it is a parent draft or a sub-draft, the drafts mentioned in the embodiments of the present disclosure contain corresponding materials and editing information corresponding to the materials. In some implementation examples, the drafts may also contain editing tracks, and the materials contained in the drafts may be presented in the form of material clips on the editing tracks.

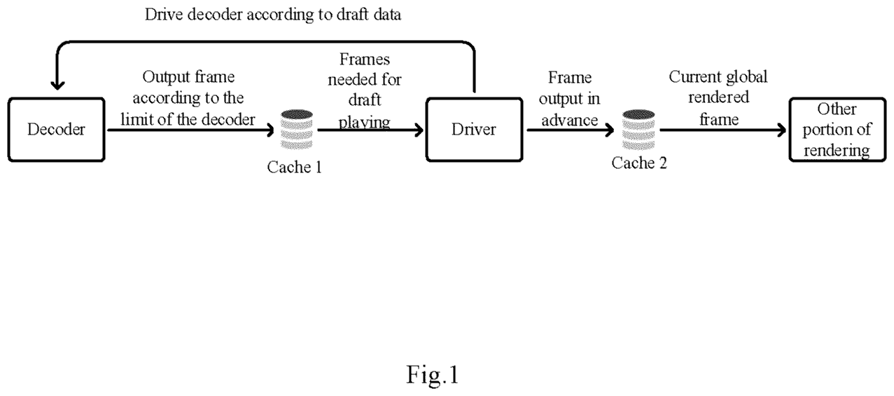

The inventors have found that the existing rendering methods for draft nesting situation are not good, and there are some problems, such as a waste of resources. Specifically, each sub-draft is simulated as a normal video at a fixed frame rate in the parent draft, and is processed as the normal video in the parent draft, and the decoding of the normal video has the following features: a video is composed of a limited number of static frames, and generally has a fixed frame rate, and has the concept of a next frame; the video is divided into GOP (Group of Pictures) according to time, and the video frames in a GOP must be decoded from front to back in sequence and cannot be skipped. Based on this, with regard to the material in the draft, a decoder and a driver (also referred to as a decoding driver, hereinafter referred to as a driver for short) may be schematically shown with reference to a schematic diagram of rendering according to a related art shown in FIG. 1. The decoder may be presented by Reader and is mainly responsible for decoding the material and outputting a material frame according to the material time. The driver may be presented by ReaderUnit, and is mainly responsible for mapping the draft time and the material time according to the draft information, using the material time to drive reader to decode, and mapping the decoding result to the draft time and outputting the decoding result to other modules for processing. Cache 1 in FIG. 1 is used for storing the result that a decoder Reader outputs frame according to GOP and the sequence with respect to a video file. The driver may drive the decoder to decode, and select a frame that a draft needs to play from cache 1 to be put into Cache 2, so as to realize frame output in advance. The current global rendering may then be performed from the frame in Cache 2, and other portions of the rendering such as effect may be performed.

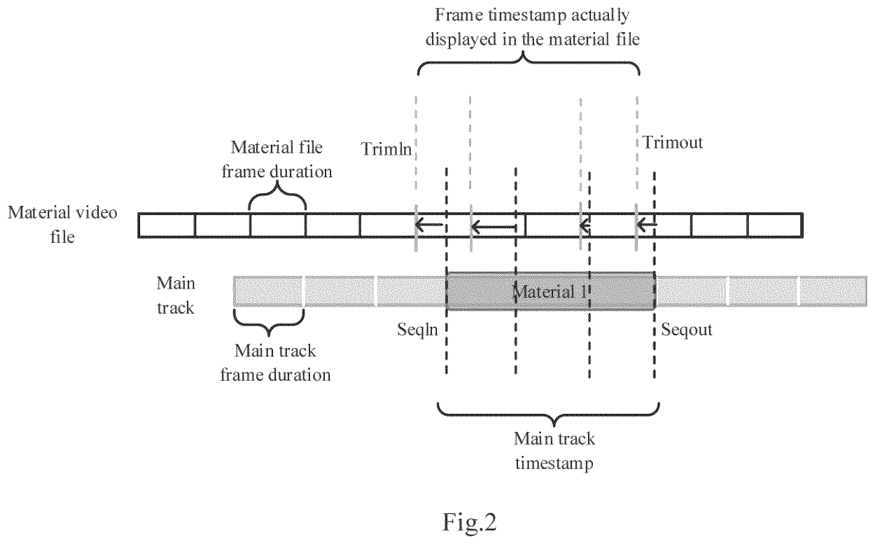

To facilitate understanding, embodiments of the present disclosure further provide a schematic diagram of the time mapping principle of a driver as shown in FIG. 2, taking video material as an example, the beginning and ending times of a segment of video itself are TrimIn and TrimOut, and the video is placed on the main track of the draft, corresponding to the times on the main track being SeqIn and SeqOut. For example, for a 20 s segment of video material A, a 10-15 s segment is intercepted and placed on position 30-35 s of the draft main track. In this case, TrimIn of the segment is 10 s, TrimOut is 15 s, a SeqIn is 30 s and a SeqOut is 35 s. The driver may determine the time mapping relationship between the draft and the track material in the draft based on these four times, which may also be referred to as determining the mapping between the timeline of the draft and the timeline of the material in the draft, thereby enabling reasonable rendering and previewing, such as displaying the picture content of the 10th s in video material A when the draft is played to the 30th s.

It should be clear that at the time of playback, it needs to calculate the timestamp (dashed black line in the figure) T_{global} of each frame of the main track and the timestamp (dashed gray line in the figure) T_{clip} of the output frame of the corresponding video material file. For the specific parsing process, reference may be made to the following five steps:
Step I: Since decoding is a time-consuming operation, it is necessary to decode forward ahead of the current time, and assuming decoding forward to the kth frame, the target main track timestamp T_{global} (k) may be calculated first:

$${T}_{global} ( k ) = {T}_{global} ( Current ) + \frac{1}{{Fps}_{g lobal}} \cdot ( k \cdot Current )$$

Where k is a frame number, and current is a current frame number. Fps_{global} indicates the main track frame rate. It should be noted that the main track is the track of the main draft, and it is expressed herein as the main track. In practical applications, other tracks of the main draft are also applicable.

That is, the timestamp of the k-th frame needs to be obtained by adding the current timestamp by a certain during (the product of the frame interval and the number of interval frames).
Step II: Checking whether T_{global} (k) is between SeqIn and SeqOut.
Step III: Mapping T_{global} (k) to T_{clip}:

$${T}_{clip} = TrimIn + SpeedFunc ( \frac{{T}_{global} ( k ) - S e q I n}{S e q I n - SeqOut} ) \cdot ( TrimOut - TrimIn )$$

SpeedFunc refers to variable-speed mapping including irregular speed changing or the like, the above function may be used to represent a mapping relationship between a timeline of a draft and a timeline of material in the draft.
Step IV: Checking if T_{clip} is out of the material duration range, i.e. confirming that T_{clip} is within the material start time (StartTime) to the material end time (i.e. StartTime+duration). Here, duration indicates the material duration.
Step V: The video material file is decoded forward until a frame duration in the decoded video material file contains the T_{clip}, and the frame is output.

As described above, in the related art, it is necessary to simulate sub-drafts as normal video material and decode from front to back so that desired material frames may be finally rendered and displayed, so that there is a large amount of useless rendering, and undesired frames are also output. To enable efficient rendering of complex drafts in which sub-drafts are nested during the preview process, embodiments of the present disclosure optimize the rendering process for the draft nesting situation.

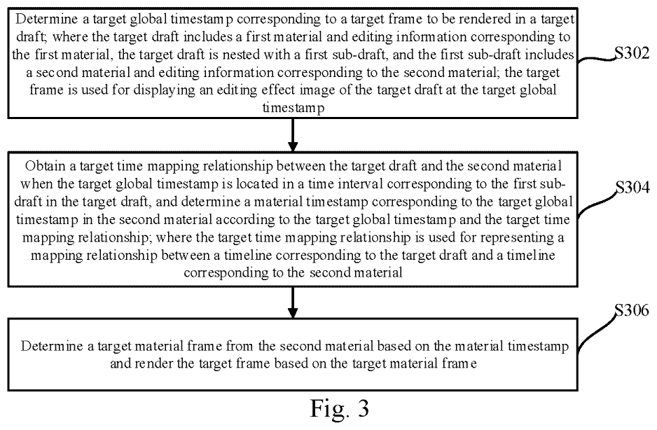

First, embodiments of the present disclosure provide a method of processing multimedia, and FIG. 3 is a schematic diagram of the flow of a method of processing multimedia provided by an embodiment of the present disclosure, which may be executed by a multimedia processing apparatus, where the apparatus may be implemented in software and/or hardware, and may be generally integrated into an electronic device. As shown in FIG. 3, the method mainly includes the following steps S302 to S306:

At step S302, determining a target global timestamp corresponding to a target frame to be rendered in a target draft, where the target draft includes a first material and editing information corresponding to the first material, and the target draft is nested with a first sub-draft, and the first sub-draft includes a second material and editing information corresponding to the second material, the target frame is used for displaying an editing effect image of the target draft at the target global timestamp.

The target draft is the currently opened draft, i.e. the main draft, and its timeline may become the main timeline. The target frame to be rendered in the target draft may be the target frame currently to be previewed or the target frame currently to be exported. In the disclosed embodiment, the target draft is nested with a first sub-draft, and the target draft may be nested directly with the first sub-draft, that is, the target draft is a parent draft of the first sub-draft, and the target draft may be nested indirectly with the first sub-draft. For example, the sub-draft with which the target draft is nested directly is a parent draft of the first sub-draft. Alternatively, the first sub-draft is a sub-draft with which the target draft is nested in multiple layers, and the first sub-draft may only contain materials such as images, audio and video, and the sub-draft may further to be nested in the first sub-draft, without being limited thereto. In the preview, the timestamp of each played frame is only related to the frame rate and time of the main timeline. The target global timestamp is a timestamp of the target frame corresponding to the timeline of the target draft, and an editing effect image of the target draft at the target global timestamp may be displayed through the target frame. In addition, for ease of distinction, the material included in the target draft is referred to as the first material, and the material included in the first sub-draft is referred to as the second material.

At step S304, obtaining a target time mapping relationship between the target draft and the second material when the target global timestamp is located in a time interval corresponding to the first sub-draft in the target draft, and determining a material timestamp corresponding to the target global timestamp in the second material according to the target global timestamp and the target time mapping relationship. The target time mapping relationship is used for representing a mapping relationship between a timeline corresponding to the target draft and a timeline corresponding to the second material. It can be understood that the material in the main draft, the sub-draft, and the draft have their corresponding timeline, and can also be understood as having a time corresponding to each file, and different timelines may have differences. However, the embodiment of the present disclosure can accurately and quickly determine the corresponding relationship between timestamps on different timelines by finding the mapping relationship between different timelines and based on the mapping relationship between different timelines. Based on this, through the mapping relationship between the timeline corresponding to the target draft and the timeline corresponding to the second material, the material timestamps corresponding to the target global timestamps in the second material can be accurately located.

At step S306, determining a target material frame from the second material based on the material timestamp, and rendering the target frame based on the target material frame. Previewing or exporting of the target frame can then be achieved. Based on knowing the second material and the material timestamp, the target material frame can be accurately obtained from the second material, and on this basis, the material content corresponding to the target frame can be rendered.

The above-mentioned rendering processing method for a draft nesting situation can support determining a target material frame only from a second material of a first sub-draft and rendering a currently required target frame on this basis, without needing to render the whole sub-draft of the target draft as a video segment for display, and therefore useless rendering and the output of unnecessary frames can be effectively avoided, and processing resources can be saved and processing efficiency can be improved.

For ease of understanding, the embodiments of the present disclosure are set forth in detail below:

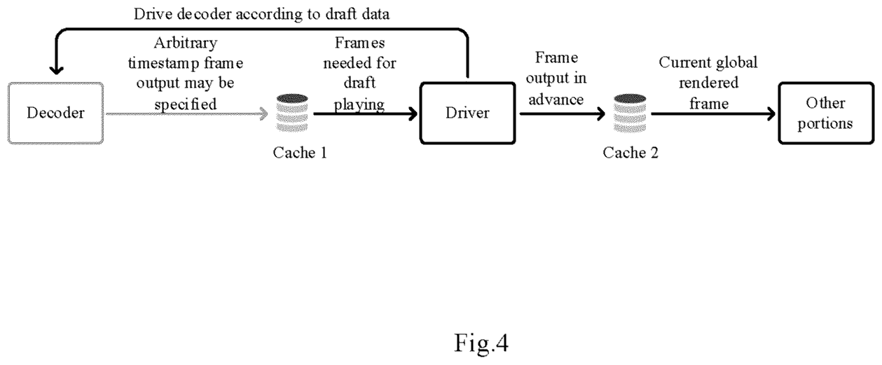

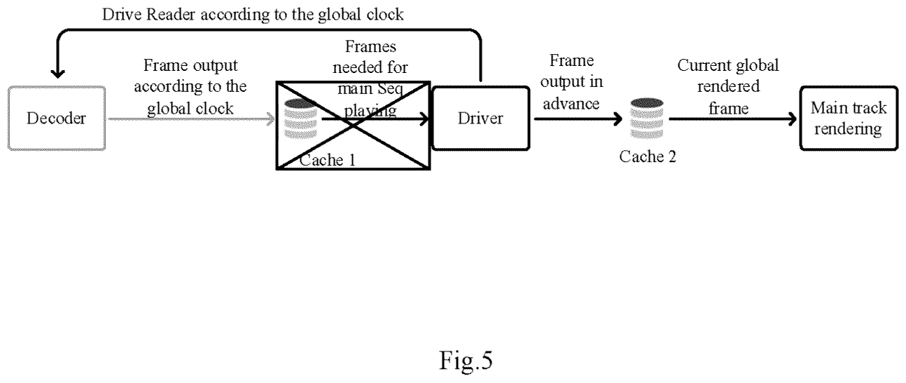

In the disclosed embodiment, a global clock (which may also be referred to as a global time) is introduced to set a frame output time T_{global} of each frame played by the editor. The global clock may indicate a start time, an end time, and a frame rate, next frame time of a given T_{global} is determined by means of an API (Application Programming Interface), etc. In other words, according to the disclosed embodiment, a global time of each frame on a track in the main draft may be determined. Based on this, all editor components can learn the global time corresponding to the frame they are running, and the decoder Reader of all material and sub-drafts can also map any global time to its own timestamp at any time. In particular, reference can be made to a schematic diagram of rendering as shown in FIG. 4 provided by an embodiment of the present disclosure, which differs from FIG. 1 mainly in that an arbitrary timestamp frame output can be specified according to the method provided by the embodiment of the present disclosure, namely, only outputting the frames needed when previewing at the frame rate of the current main timeline can be supported, and useless rendering can be avoided. Specifically, a corresponding decoder, which may be simply referred to as a SeqReader, may be specially provided for the sub-draft in the parent draft to realize the sub-draft rendering. The material rendering inside the sub-draft would be in the decoder SeqReader, and the same driving mechanism as that of the above-mentioned decoder Reader would be repeated, but the sub-draft time and content are used. According to an embodiment of the present disclosure, upon creating a global clock, a parent draft may drive a sub-draft, and set a global time and mapping for the sub-draft. In particular, reference can be made to a schematic diagram of rendering shown in FIG. 5, and FIG. 5 is a specific example of FIG. 4. In FIG. 5, it is clearly shown that the Cache 1 is removed, mainly for the following reasons: all frames are frames that are needed for global play so that frames that are not needed are not rendered and placed in Cache 1.

In a specific implementation, when the decoder SeqReader corresponding to the sub-draft is created, the driver ReaderUnit provides the decoder SeqReader with a mapping function of T_{global} to T_{seq}, and the mapping function can be referred to the relevant contents of the third step in the above-mentioned parsing process, and will not be described in detail here. When a frame is played, the driver ReaderUnit may input the T_{global} of the frame to the decoder SeqReader, and in this way, the decoder SeqReader can calculate any frame T_{seq} played on the track at any moment according to the global time and the mapping function.

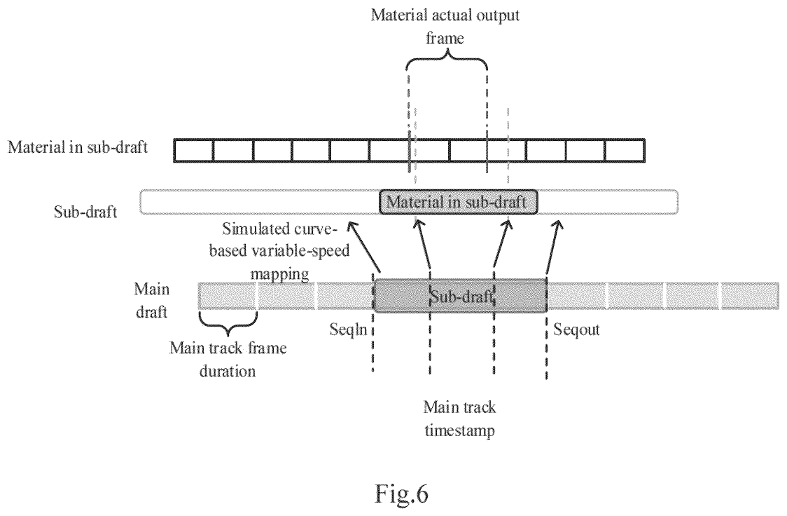

Based on the foregoing, embodiments of the present disclosure further provide a specific example in which the sub-draft drives the internal material using a global clock. Referring to a schematic diagram of a time mapping principle of a driver shown in FIG. 6, the timestamp of the main draft needs to be mapped to the sub-draft and then mapped from the sub-draft to the internal material of the sub-draft, so as to ensure that the internal material of the sub-draft plays normally. The decoder SeqReader corresponding to the sub-draft receives the global time and the mapping function, so as to obtain the T_{seq} corresponding to any frame played on the track in the main draft, and then calculates the mapping from the T_{seq} to the T_{clip} based on the contents of the sub-draft, so as to obtain the T_{clip} corresponding to each global frame. In this way, the timestamps of the frames to be decoded in all the materials can be predicted. FIG. 6 also illustrates that the material in the sub-draft has processing such as speed change. It can be understood that one of the main differences between the sub-draft rendering and the main draft rendering is that the frame output of the sub-draft is not uniform, especially in the scene of curve speed change and reverse playback. For internal material, the frame output of the draft is not uniform, which means that the next frame time cannot be predicted to decode or drop the frame in advance, resulting in wasted performance. With a global clock, all the frame timestamps are predictable, and reasonable frame drop and decoding can also be achieved.

Based on the foregoing, in some embodiments, the obtaining the target time mapping function between the target draft and the target frame may be performed with reference to the following steps A-C:

At step A, obtaining a first time mapping relationship, where the first time mapping relationship is used for representing a mapping relationship between a timeline corresponding to the target draft and a timeline corresponding to the first sub-draft.

In practical applications, when there are a plurality of layers of sub-draft nested in a target draft, a mapping relationship between a timeline corresponding to the target draft and a timeline corresponding to each layer of sub-draft in the target draft can be obtained and saved in advance. A mapping relationship between the timeline corresponding to the target draft and a timeline corresponding to a second sub-draft in the plurality of layers of sub-draft is determined based on a mapping relationship between the timeline corresponding to the target draft and a timeline corresponding to a parent draft of the second sub-draft and a mapping relationship between the timeline corresponding to the parent draft of the second sub-draft and the timeline corresponding to the second sub-draft. The target draft and the second sub-draft are in an indirect nesting relationship, and there may be one or more layers of sub-drafts between the target draft and the second sub-draft, and there is no restriction here. In practical applications, if the first sub-draft is a sub-draft directly nested in the target draft, then the first sub-draft does not belong to the second sub-draft, and specifically, the second sub-draft is directly or indirectly nested in the first sub-draft. If the first sub-draft is also a sub-draft indirectly nested in the target draft, then the second sub-draft referred to herein is considered equivalent to the first sub-draft described above. In the above-mentioned manner, a mapping relationship between a global time corresponding to a target draft and a time corresponding to each layer of sub-drafts in the target draft can be determined efficiently and conveniently. In some specific embodiments, the mapping relationship may be presented by a mapping function.

For ease of understanding, the following is exemplary for the case of a plurality of layers of sub-draft are nested. Suppose that there is a sub-draft seq[1] in the main track of the main draft, and there is a sub-draft seq[2] in seq[1], and the material is material in seq[2]. The above-mentioned seq[1] corresponds to the above-mentioned first sub-draft, and the seq[2] corresponds to the above-mentioned second sub-draft.

In order to display the material in the second sub-draft, the T_{global} needs to be mapped to the T_{clip}, then:

$${T}_{s e q [ 1 ]} = {F}_{global ↦ s e q [ 1 ]} ( {T}_{global} )$$

$${T}_{s e q [ 2 ]} = {F}_{s e q [ 1 ] ↦ s e q [ 2 ]} ( {T}_{s e q [ 1 ]} )$$

$${T}_{c l i p} = {F}_{s e q [ 2 ] ↦ c l i p} ( {T}_{s e q [ 2 ]} )$$

F_{global→seg1} can only be found in the main draft, F_{seq1→seg2} needs to be found in the seq[1] draft, F_{seq2→clip} needs to be found in the seq[2] draft.

So for the decoder ReaderUnit of seq[2], in order to obtain the T_{clip} accurately, it is necessary to access the data of each layer, but this way of direct access is not very feasible. To this end, according to the embodiment of the present disclosure, when setting the decoder SeqReader of the seq[2] draft, the callback function set is not F_{seq1→seq2} but F_{global→seq2}. In the code implementation, for a decoder SeqReader of any kth layer sub-draft, it only needs to save its own F_{global→seq[k]}, the F_{global→seq[k+1]} corresponds to the inner (k+1)^{th} layer sub-draft thereof can be conveniently calculated:

$${F}_{global ↦ s e q [ k + 1 ]} ( t ) = {F}_{s e q [ k ] ↦ s e q [ k + 1 ]} ( {F}_{global ↦ s e q [ k ]} ( t ) )$$

Here, only the track data in the seq[k] draft is needed in F_{seq[k]→seq[k+1]}.

In this way, the decoder SeqReader of a sub-draft may save the mapping relationship from T_{global} to T_{seq}, and can directly support a plurality of layers of sub-draft that are nested under the condition that each draft data is isolated.

At step B, obtaining a second time mapping relationship, where the second time mapping relationship is used for representing a mapping relationship between a timeline corresponding to the first sub-draft and a timeline corresponding to a second material in the first sub-draft. Specific implementations of the second time mapping relationship may be referred to in the foregoing and will not be described in detail herein.

At step C, obtaining a target time mapping relationship between the target draft and the second material based on the first time mapping relationship and the second time mapping relationship.

In the above-mentioned manner, the target time mapping relationship between the target draft and the second material can be conveniently and quickly obtained.

A method provided by embodiments of the present disclosure further includes: determining a playback state of the second material based on a material timestamp corresponding to the target global timestamp in the second material and a material timestamp corresponding to a material frame located before the target material frame in the second material, where the playback state includes one or more of a forward playback state, a reverse playback state, a slow-forward state, and a fast-forward state. That is, by setting a global visible global clock and determining the frame output time T_{global} of each frame, it is possible to predict the frame output situation of any material and sub-drafts, so as to perform targeted processing. For example, in the case of multiple times of curve speed change and reverse playback are nested, it is clear and convenient to learn whether a material is being forward playback or reverse playback, and whether it is slow-forward playback or fast-forward playback in combination with information of each frame, so as to perform corresponding targeted processing.

Further, according to embodiments of the present disclosure, in order to solve the problem of audio-video desynchronization in multimedia processing, frame drop processing is usually performed. In particular, when the video processing speed is slower than the audio playing speed, part of the frames may be skipped to be no longer rendered during video playing, so as to catch up with the audio playing progress, thereby achieving an audio-picture synchronization effect. Therefore, before the target frame is rendered based on the target material frame, and in particular after the target frame is determined, the method provided by the embodiments of the present disclosure may further include: querying a frame drop table, where a frame drop moment in the target draft is recorded in the frame drop table; and dropping the target frame when the frame drop table indicates that the target global timestamp belongs to a frame drop moment. That is, the target frame may be rendered only if the frame drop table indicates that the target global timestamp does not belong to the frame drop moment, otherwise, the frame may be skipped. Embodiments of the present disclosure may pre-establish and update a frame drop table in which a frame drop moment is recorded. Illustratively, the frame drop moment is recorded in the frame drop table as follows: determining a frame drop moment in the target draft in response to detecting that the target draft has an audio-video desynchronization problem when the target draft is currently in a playback state. The frame drop moment is recorded in a frame drop table. It should be noted that the precondition of frame drop processing is that the target draft is currently in a playback state. In other words, if it is not in a playback state, frame drop processing is not performed, because audio-visual synchronization is required only when the draft is in a playback state, and frame dropping is not required for the rest of the scenes.

Embodiments of the present disclosure further provide a way to determine the occurrence of audio-video desynchronization problem: determining that the audio-video desynchronization problem occurs in the target draft when detecting that a global timestamp of a currently played audio is greater than a specified global timestamp, where the specified global timestamp is equal to the sum of a global timestamp of a frame to be presented for which rendering is completed and a single frame duration of the frame to be presented. It will be appreciated that the global timestamp of the frame to be presented is the start time of the frame to be presented, and the frame to be presented usually has a duration, so that the global timestamp of the frame to be presented and a single frame duration of the frame to be presented need to be summed and then compared with the global timestamp of the audio. By the above-mentioned method, it is possible to accurately and conveniently judge whether there is a problem with audio-video desynchronization.

Illustratively, the frame drop moment in the target draft may be determined by referring to the following steps a-c:

At step a, taking a global timestamp of a frame currently starting to be rendered as a frame drop start moment. It should be noted that a frame drop start moment does not belong to a frame drop moment and is merely used as a starting point for starting a frame drop, in particular, only the next moment of the frame drop starting moment actually belongs to the frame drop moment. In this way, it can be effectively ensured that a frame being rendered is not dropped.

At step b, taking a minimum value between a global timestamp of a currently played audio and an end timestamp of the audio as a frame drop end moment.

At step c, determining a frame drop moment in the target draft based on a moment between the frame drop start moment and the frame drop end moment. For example, the moment between the frame drop start moment and the frame drop end moment may both be determined as a frame drop moment; or, according to a preset interval, an exempt frame is extracted from the moment between the frame drop start moment and the frame drop end moment, and the moment other than the exempt frame from the moment between the frame drop start moment and the frame drop end moment may be determined as a frame drop moment. In practical applications, time-consuming spurs that can catch up and persistent long time-consuming frames that cannot catch up can be identified. Frames need to be dropped in case of spurs, and persistent long time-consuming frames need to be reserved to ensure the frame rate. In particular implementations, for example, an exempt frame may be extracted every three frames, in other words, one frame may be left for every three frames dropped, i.e. a portion of the frame may be uniformly retained, so as to ensure a certain frame rate, such as 6 fps frame rate.

In order to achieve the above-mentioned contents, embodiments of the present disclosure provide a global frame drop management system using global clock mapping, which may start up when a draft is in a playback state, and collect the following four timestamps: 1) A global timestamp of a frame currently starting to be rendered, which may be presented by a RenderStartedTime; 2) The global timestamp of the frame to be presented after the rendering is completed, which may be presented by ReadyToDisplayTime; 3) The global timestamp of the currently played audio, which may be presented by the AudioTime; 4) The end timestamp of the audio, which may be presented by AudioDuration. It should be noted that, with regard to a global frame drop management system, all the timestamps involved are global timestamps, namely, whether a frame is dropped is only related to a T_{global}.

The frame drop policy adopted by the global frame drop management system is: at the ReadyToDisplay and Audio Time update, test and perform the following steps 1-5:

At step 1, when it is detected that AudioTime>ReadyToDisplayTime+FrameDuration, determining that the problem of audio-video desynchronization occurs, and then a frame drop calculation is started.

At step 2, ensuring that the frame being rendered is not dropped, and taking the next frame moment of the RenderStartedTime as a frame drop moment.

At step 3, marking all frames within (RenderStartedTime, min {AudioTime, AudioDuration}) as dropped.

At step 4, exempting the dropped frame in Step 3. Illustratively, a portion of the frames within (RenderStartedTime, min {AudioTime, AudioDuration}) may be uniformly reserved, so as to ensure a specified frame rate such as 6 fps.

At step 5, writing the frame that is decided to be dropped into a frame drop table.

In practical application, the above-mentioned decoder Reader and driver ReaderUnit actively query the global frame drop management system whether the global time T_{global} currently being processed is in the frame drop table or not before decoding or rendering. If it is in the frame drop table, the frame is skipped automatically and the next frame is processed.

In addition, it should be noted that audio-visual synchronization only makes sense for tracks in the main draft, in other words, whether a frame is dropped or not depends mainly on the T_{global} to which the frame corresponds. When it is determined that a frame needs to be dropped, all the decoding and rendering tasks corresponding to the frame, including all the parts in the sub-draft, are no longer needed, that is to say, all the contents corresponding to the T_{global} need to be dropped. In other words, when the preview of the main timeline has an audio-video desynchronization problem, the rendering process of the sub-draft needs to be synchronized with the main timeline to drop a frame. However, the frame being rendered is not dropped as much as possible to avoid redundant processing. The above-mentioned global frame drop management system records the moment T_{global} when frames need to be dropped so that the decoder Reader and the driver ReaderUnit corresponding to all the drafts and materials can accurately and timely learn whether a frame thereof needs to be dropped by mapping the time thereof to the global time, so as to realize frame drop processing in time.

In summary, the method of processing multimedia provided by the embodiments of the present disclosure realizes global zero redundancy rendering by introducing a global clock and providing a global time and a corresponding time mapping relationship to each sub-draft and sub-material so as to decode and render each sub-draft and sub-material according to a global frame output requirement. Furthermore, by saving a mapping relationship between a global timeline T_{global} and a local timeline T_{seq} in a decoder SeqReader corresponding to each layer of sub-drafts, it is possible to support a plurality of layers of sub-draft that are nested under the condition that the separation of draft data is satisfied. Furthermore, by providing the above-mentioned global time-based global frame drop system, each component maintains its own corresponding global clock, and all decoding components can perform uniform and timely frame drop processing on a certain played frame.

Furthermore, based on the above-mentioned manner provided by the embodiments of the present disclosure, it can be better applied to a draft nesting scene, and a rendering processing manner for a draft nesting situation can be better optimized. By means of the above-mentioned method, it is possible to avoid redundant rendering of sub-drafts for each frame and the output of frames which are not needed in global playing, to avoid resource waste, to improve processing efficiency, and to improve system performance. In addition, the above-mentioned method can also be preferably applied to a sub-draft speed change scenario, and multiple speed changes can improve multiple performances so that the user experience can be optimized from severe jamming to a smooth feel. In addition, for the problem of audio-video desynchronization, the above-mentioned method can also achieve the effect of global uniform frame drop which cannot be supported by the traditional scheme, and the video editor can recover from the audio-video desynchronization state more quickly in the process of preview playing, so that the user experience is more fluent.

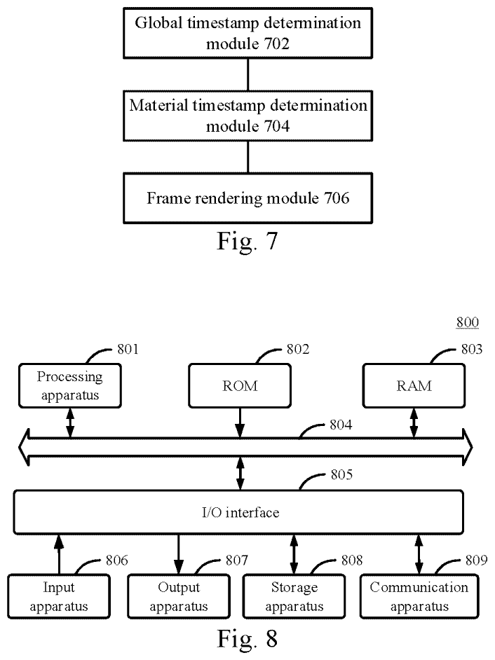

Corresponding to the above-mentioned method of processing multimedia, the embodiment of the present disclosure further provides a multimedia processing apparatus. FIG. 7 is a schematic diagram of the structure of a multimedia processing apparatus provided by the embodiment of the present disclosure, and the apparatus may be implemented by software and/or hardware and may be generally integrated into an electronic device. As shown in FIG. 7, the multimedia processing apparatus includes:
a global timestamp determination module 702, configured to determine a target global timestamp corresponding to a target frame to be rendered in a target draft, where the target draft includes a first material and editing information corresponding to the first material, and the target draft is nested with a first sub-draft, the first sub-draft includes a second material and editing information corresponding to the second material; the target frame is used for displaying an editing effect image of the target draft at the target global timestamp;
a material timestamp determination module 704, configured to obtain a target time mapping relationship between the target draft and the second material when the target global timestamp is located in a time interval corresponding to the first sub-draft in the target draft, and to determine a material timestamp corresponding to the target global timestamp in the second material according to the target global timestamp and the target time mapping relationship, where the target time mapping relationship is used for representing a mapping relationship between a timeline corresponding to the target draft and a timeline corresponding to the second material;
a frame rendering module 706, configured to determine a target material frame from the second material based on the material timestamp, and to render the target frame based on the target material frame.

In some embodiments, the material timestamp determination module 704 is specifically configured to: obtain a first time mapping relationship, where the first time mapping relationship is used for representing a mapping relationship between a timeline corresponding to the target draft and a timeline corresponding to the first sub-draft; obtain a second time mapping relationship, where the second time mapping relationship is used for representing a mapping relationship between a timeline corresponding to the first sub-draft and a timeline corresponding to a second material in the first sub-draft; and obtain a target time mapping relationship between the target draft and the second material based on the first time mapping relationship and the second time mapping relationship.

In some embodiments, the apparatus further includes a function saving module, configured to obtain and save a mapping relationship between a timeline corresponding to the target draft and a timeline corresponding to each layer of sub-draft in the target draft when the target draft has a plurality of layers of sub-draft that are nested. A mapping relationship between the timeline corresponding to the target draft and a timeline corresponding to a second sub-draft in the a plurality of layers of sub-draft is determined based on a mapping relationship between the timeline corresponding to the target draft and a timeline corresponding to a parent draft of the second sub-draft and a mapping relationship between the timeline corresponding to the parent draft of the second sub-draft and the timeline corresponding to the second sub-draft. The target draft and the second sub-draft are in an indirect nesting relationship.

In some embodiments, the apparatus further includes a state determination module, configured to determine a playback state of the second material based on a material timestamp corresponding to the target global timestamp in the second material and a material timestamp corresponding to a material frame located before the target material frame in the second material. The playback state includes one or more of a forward playback state, a reverse playback state, a slow-forward state, and a fast-forward state.

In some embodiments, the apparatus further includes a frame drop module configured to: query a frame drop table, a frame drop moment in the target draft is recorded in the frame drop table; and drop the target frame when the frame drop table indicates that the target global timestamp belongs to a frame drop moment.

In some embodiments, the apparatus further includes a frame drop moment recording module configured to record the frame drop moment in a frame drop table by: determining the frame drop moment in the target draft in response to detecting that the target draft has an audio-video desynchronization problem when the target draft is currently in a playback state; and recording the frame drop moment in a frame drop table.

In some embodiments, the apparatus further includes a problem determination module configured to determine that the audio-video desynchronization problem occurs in the target draft when detecting that a global timestamp of a currently played audio is greater than a specified global timestamp, where the specified global timestamp is equal to the sum of a global timestamp of a frame to be presented for which rendering is completed and a single frame duration of the frame to be presented.

In some embodiments, the frame drop moment recording module is specifically configured to: take a global timestamp of a frame currently starting to be rendered as a frame drop start moment; take a minimum value between a global timestamp of the currently played audio and an end timestamp of the currently played audio as a frame drop end moment; and determine the frame drop moment in the target draft based on a moment between the frame drop start moment and the frame drop end moment.

In some embodiments, the frame drop moment recording module is specifically configured to: determine a moment between the frame drop start moment and the frame drop end moment as a frame drop moment; or, extract an exempt frame from the moment between the frame drop start moment and the frame drop end moment according to a preset interval, and determine the moment other than the exempt frame from the moment between the frame drop start moment and the frame drop end moment as the frame drop moment.

A multimedia processing apparatus provided by an embodiment of the present disclosure can execute a method of processing multimedia provided by any embodiment of the present disclosure and has functional modules and advantageous effects corresponding to the execution method.

It will be clear to a person skilled in the art that, for the sake of convenience and brevity of description, reference may be made to corresponding processes in method embodiments for the specific working processes of the above-described apparatus embodiments, which will not be described in greater detail herein.

An embodiment of the present disclosure provides an electronic device including: a memory on which a computer program is stored; and at least one processing apparatus for executing the computer program in the memory for implementing the steps of the method of processing multimedia of the present disclosure.

Reference is now made to FIG. 8, which illustrates a schematic structure diagram of an electronic device 800 suitable for implementing an embodiment of the present disclosure. Terminal devices in embodiments of the present disclosure may include but are not limited to, mobile terminals such as mobile phones, notebook computers, digital broadcast receivers, PDA (personal digital assistants), PAD (tablet computers), PMP (portable multimedia players), vehicle-mounted terminals (e.g. vehicle navigation terminals), and the like, and fixed terminals such as digital TVs, desktop computers, and the like. The electronic device shown in FIG. 8 is merely an example and should not pose any limitation on the scope of use or functionality of the disclosed embodiments.

As shown in FIG. 8, an electronic device 800 may include a processing apparatus (e.g. central processing unit, graphics processor, etc.) 801 that may perform various suitable actions and processes in accordance with a program stored in a read-only memory (ROM) 802 or a program loaded from a storage apparatus 808 into a random access memory (RAM) 803. In the RAM 803, various programs and data required for the operation of the electronic device 800 are also stored. The processing apparatus 801, the ROM 802, and the RAM 803 are connected to each other via a bus 804. An input/output (I/O) interface 805 is also connected to the bus 804.

In general, the following apparatus may be connected to the I/O interface 805: input apparatus 806 including, for example, touch screens, touch pads, keyboards, mice, cameras, microphones, accelerometers, gyroscopes, etc.; an output apparatus 807 including, for example, a liquid crystal display (LCD), a speaker, a vibrator, and the like; a storage apparatus 808 including, for example, a magnetic tape, a hard disk, etc.; and a communication apparatus 809. The communication apparatus 809 may allow the electronic device 800 to communicate wirelessly or wiredly with other devices to exchange data. Although FIG. 8 illustrates an electronic device 800 with various apparatus, it is to be understood that not all illustrated apparatus is required to be implemented or provided. More or fewer apparatus may alternatively be implemented or provided.

In particular, the processes described above with reference to the flow diagrams may be implemented as computer software programs in accordance with embodiments of the present disclosure. For example, embodiments of the present disclosure include a computer program product including a computer program embodied on a non-transitory computer-readable medium, the computer program containing program code for performing the methods illustrated in the flowcharts. In such an embodiment, the computer program may be downloaded and installed from the network via the communication apparatus 809, or from the storage apparatus 808, or from the ROM 802. The computer program, when executed by the processing apparatus 801, performs the above-described functions defined in the method of the embodiment of the present disclosure.

In addition to the methods and devices described above, embodiments of the present disclosure may also be a computer program product including computer program instructions which, when executed by a processor, cause the processor to perform the methods provided by embodiments of the present disclosure. The computer program product may write program code for performing operations of embodiments of the present disclosure in any combination of one or more programming languages, including object-oriented programming languages, such as Java, C++, etc., and conventional procedural programming languages, such as the “C” language or similar programming languages. The program code may execute entirely on the user computing device, partially on the user device, as a stand-alone software package, partially on the user computing device, partially on a remote computing device, or entirely on the remote computing device or server.

Furthermore, embodiments of the present disclosure may also be a computer-readable storage medium having stored thereon computer program instructions which, when executed by a processor, cause the processor to perform a method of processing multimedia provided by embodiments of the present disclosure.

The computer-readable storage medium may take any combination of one or more of the readable media. The readable medium may be a readable signal medium or a readable storage medium. The readable storage medium may include, for example, but not limited to, an electronic, magnetic, optical, electromagnetic, infrared, or semiconductor system, apparatus, or device, or any combination thereof. More specific examples (a non-exhaustive list) of the readable storage medium include: an electrical connection having one or more wires, a portable disk, a hard disk, a random access memory (RAM), a read-only memory (ROM), an erasable programmable read-only memory (EPROM or Flash memory), an optical fiber, a portable compact disk read-only memory (CD-ROM), an optical storage apparatus, a magnetic storage apparatus, or any suitable combination thereof.

Embodiments of the present disclosure also provide a computer program product including computer programs/instructions that, when executed by a processor, implement the method of processing multimedias of embodiments of the present disclosure.

It should be understood that, before using the technical solutions disclosed in each embodiment of the present disclosure, the user should be informed of the type, scope of use, use scenario, etc. of personal information involved in the present disclosure and be authorized by the user in an appropriate manner in accordance with relevant laws and regulations.

For example, in response to receiving a user's active request, prompt information is sent to the user to explicitly prompt the user that the operation requested to be performed will obtain and use the personal information of a user. Thus, a user can autonomously select whether to provide personal information to software or hardware, such as an electronic device, an application program, a server, or a storage medium, which performs the operation of the technical solution of the present disclosure, according to the prompt information.

As an alternative but non-limiting implementation, in response to receiving the user's active request, the manner in which the reminder information is sent to the user may be, for example, in the form of a pop-up window in which the reminder information may be presented in the text. In addition, the pop-up window may also carry a selection control for the user to select either “agree” or “disagree” to provide personal information to the electronic device.

It is to be understood that the above-described processes of noticing and obtaining user authorization are merely illustrative and are not limiting of implementations of the present disclosure, as other ways of satisfying relevant laws and regulations may also be applied to implementations of the present disclosure.

It is to be understood that the use of relational terms such as “first” and “second” and the like herein are used solely to distinguish one entity or action from another entity or action without necessarily requiring or implying any actual such relationship or order between such entities or actions. Furthermore, the terms “comprise”, “include”, or any other variation thereof, are intended to cover a non-exclusive inclusion, such that a process, method, article, or device that includes a list of elements does not include only those elements but may include other elements not expressly listed or inherent to such process, method, article, or device. An element proceeded by the phrase “comprises a” does not, without more constraints, preclude the existence of additional identical elements in the process, method, article, or device that includes the element.

The previous description of the disclosure is merely exemplary in nature and is intended to enable any person skilled in the art to make or use the disclosure. Various modifications to these embodiments will be readily apparent to those skilled in the art, and the generic principles defined herein may be implemented in other embodiments without departing from the spirit or scope of the disclosure. Thus, the disclosure is not intended to be limited to the embodiments shown herein but is to be accorded the widest scope consistent with the principles and novel features disclosed herein.

1. A method of processing multimedia, comprising:
determining a target global timestamp corresponding to a target frame to be rendered in a target draft; wherein the target draft comprises a first material and editing information corresponding to the first material, and the target draft is nested with a first sub-draft, the first sub-draft comprises a second material and editing information corresponding to the second material; the target frame is used for displaying an editing effect image of the target draft at the target global timestamp;
obtaining a target time mapping relationship between the target draft and the second material when the target global timestamp is located in a time interval corresponding to the first sub-draft in the target draft, and determining a material timestamp corresponding to the target global timestamp in the second material according to the target global timestamp and the target time mapping relationship, wherein the target time mapping relationship is used for representing a mapping relationship between a timeline corresponding to the target draft and a timeline corresponding to the second material; and
determining a target material frame from the second material based on the material timestamp, and rendering the target frame based on the target material frame.

2. The method according to claim 1, wherein the obtaining a target time mapping relationship between the target draft and the second material comprises:
obtaining a first time mapping relationship, wherein the first time mapping relationship is used for representing a mapping relationship between a timeline corresponding to the target draft and a timeline corresponding to the first sub-draft;
obtaining a second time mapping relationship, wherein the second time mapping relationship is used for representing a mapping relationship between the timeline corresponding to the first sub-draft and a timeline corresponding to a second material in the first sub-draft; and
obtaining a target time mapping relationship between the target draft and the second material based on the first time mapping relationship and the second time mapping relationship.

3. The method according to claim 1, further comprising:
obtaining and saving a mapping relationship between a timeline corresponding to the target draft and a timeline corresponding to each layer of sub-draft in the target draft when the target draft comprises a plurality of layers of sub-draft that are nested;
wherein a mapping relationship between the timeline corresponding to the target draft and a timeline corresponding to a second sub-draft in the a plurality of layers of sub-draft is determined based on a mapping relationship between the timeline corresponding to the target draft and a timeline corresponding to a parent draft of the second sub-draft and a mapping relationship between the timeline corresponding to the parent draft of the second sub-draft and the timeline corresponding to the second sub-draft; wherein the target draft and the second sub-draft are in an indirect nesting relationship.

4. The method according to claim 1, further comprising:
determining a playback state of the second material based on the material timestamp corresponding to the target global timestamp in the second material and a material timestamp corresponding to a material frame located before the target material frame in the second material, wherein the playback state comprises at least one selected from the group consisting of a forward playback state, a reverse playback state, a slow-forward state, and a fast-forward state.

5. The method according to claim 1, wherein before rendering the target frame based on the target material frame, the method further comprises:
querying a frame drop table, wherein a frame drop moment in the target draft is recorded in the frame drop table; and
dropping the target frame when the frame drop table indicates that the target global timestamp belongs to the frame drop moment.

6. The method according to claim 5, wherein the frame drop moment is recorded in the frame drop table by:
determining the frame drop moment in the target draft in response to detecting that the target draft has an audio-video desynchronization problem when the target draft is currently in a playback state; and
recording the frame drop moment in the frame drop table.

7. The method according to claim 6, further comprising:
determining that the audio-video desynchronization problem occurs in the target draft when detecting that a global timestamp of a currently played audio is greater than a specified global timestamp, wherein the specified global timestamp is equal to the sum of a global timestamp of a frame to be presented for which rendering is completed and a single frame duration of the frame to be presented.

8. The method according to claim 6, wherein the determining the frame drop moment in the target draft comprises:
taking a global timestamp of a frame currently starting to be rendered as a frame drop start moment;
taking a minimum value between the global timestamp of the currently played audio and an end timestamp of the currently played audio as a frame drop end moment; and
determining the frame drop moment in the target draft based on a moment between the frame drop start moment and the frame drop end moment.

9. The method according to claim 8, wherein the determining the frame drop moment in the target draft based on a moment between the frame drop start moment and the frame drop end moment, comprises:
determining a moment between the frame drop start moment and the frame drop end moment as a frame drop moment; or
extracting an exempt frame from the moment between the frame drop start moment and the frame drop end moment according to a preset interval, and determining the moment other than the exempt frame from the moment between the frame drop start moment and the frame drop end moment as the frame drop moment.

10. An electronic device, comprising:
a memory on which a computer program is stored;
at least one processor for executing the computer program in the memory, wherein the at least one processor, when executing the computer program, implements a method of processing multimedia, the method of processing multimedia comprises:
determining a target global timestamp corresponding to a target frame to be rendered in a target draft; wherein the target draft comprises a first material and editing information corresponding to the first material, and the target draft is nested with a first sub-draft, the first sub-draft comprises a second material and editing information corresponding to the second material; the target frame is used for displaying an editing effect image of the target draft at the target global timestamp;
obtaining a target time mapping relationship between the target draft and the second material when the target global timestamp is located in a time interval corresponding to the first sub-draft in the target draft, and determining a material timestamp corresponding to the target global timestamp in the second material according to the target global timestamp and the target time mapping relationship, wherein the target time mapping relationship is used for representing a mapping relationship between a timeline corresponding to the target draft and a timeline corresponding to the second material; and
determining a target material frame from the second material based on the material timestamp, and rendering the target frame based on the target material frame.

11. The electronic device according to claim 10, wherein the obtaining a target time mapping relationship between the target draft and the second material comprises:
obtaining a first time mapping relationship, wherein the first time mapping relationship is used for representing a mapping relationship between a timeline corresponding to the target draft and a timeline corresponding to the first sub-draft;
obtaining a second time mapping relationship, wherein the second time mapping relationship is used for representing a mapping relationship between the timeline corresponding to the first sub-draft and a timeline corresponding to a second material in the first sub-draft; and
obtaining a target time mapping relationship between the target draft and the second material based on the first time mapping relationship and the second time mapping relationship.

12. The electronic device according to claim 10, the at least one processor is further configured to:
obtain and saving a mapping relationship between a timeline corresponding to the target draft and a timeline corresponding to each layer of sub-draft in the target draft when the target draft comprises a plurality of layers of sub-draft that are nested;
wherein a mapping relationship between the timeline corresponding to the target draft and a timeline corresponding to a second sub-draft in the a plurality of layers of sub-draft is determined based on a mapping relationship between the timeline corresponding to the target draft and a timeline corresponding to a parent draft of the second sub-draft and a mapping relationship between the timeline corresponding to the parent draft of the second sub-draft and the timeline corresponding to the second sub-draft; wherein the target draft and the second sub-draft are in an indirect nesting relationship.

13. The electronic device according to claim 10, the at least one processor is further configured to:
determine a playback state of the second material based on the material timestamp corresponding to the target global timestamp in the second material and a material timestamp corresponding to a material frame located before the target material frame in the second material, wherein the playback state comprises at least one selected from the group consisting of a forward playback state, a reverse playback state, a slow-forward state, and a fast-forward state.

14. The electronic device according to claim 10, wherein before rendering the target frame based on the target material frame, the at least one processor is further configured to:
query a frame drop table, wherein a frame drop moment in the target draft is recorded in the frame drop table; and
drop the target frame when the frame drop table indicates that the target global timestamp belongs to the frame drop moment.

15. The electronic device according to claim 14, wherein the frame drop moment is recorded in the frame drop table by:
determining the frame drop moment in the target draft in response to detecting that the target draft has an audio-video desynchronization problem when the target draft is currently in a playback state; and
recording the frame drop moment in the frame drop table.

16. A non-transitory computer-readable storage medium, wherein the non-transitory computer-readable storage medium stores computer program, and when the computer program is executed by a processor, the processor is caused to implement a method of processing multimedia, the method comprises:
determining a target global timestamp corresponding to a target frame to be rendered in a target draft; wherein the target draft comprises a first material and editing information corresponding to the first material, and the target draft is nested with a first sub-draft, the first sub-draft comprises a second material and editing information corresponding to the second material; the target frame is used for displaying an editing effect image of the target draft at the target global timestamp;
obtaining a target time mapping relationship between the target draft and the second material when the target global timestamp is located in a time interval corresponding to the first sub-draft in the target draft, and determining a material timestamp corresponding to the target global timestamp in the second material according to the target global timestamp and the target time mapping relationship, wherein the target time mapping relationship is used for representing a mapping relationship between a timeline corresponding to the target draft and a timeline corresponding to the second material; and
determining a target material frame from the second material based on the material timestamp, and rendering the target frame based on the target material frame.

17. The non-transitory computer-readable storage medium according to claim 16, wherein the obtaining a target time mapping relationship between the target draft and the second material comprises:
obtaining a first time mapping relationship, wherein the first time mapping relationship is used for representing a mapping relationship between a timeline corresponding to the target draft and a timeline corresponding to the first sub-draft;
obtaining a second time mapping relationship, wherein the second time mapping relationship is used for representing a mapping relationship between the timeline corresponding to the first sub-draft and a timeline corresponding to a second material in the first sub-draft; and
obtaining a target time mapping relationship between the target draft and the second material based on the first time mapping relationship and the second time mapping relationship.

18. The non-transitory computer-readable storage medium according to claim 16, the processor is further configured to:
obtain and saving a mapping relationship between a timeline corresponding to the target draft and a timeline corresponding to each layer of sub-draft in the target draft when the target draft comprises a plurality of layers of sub-draft that are nested;
wherein a mapping relationship between the timeline corresponding to the target draft and a timeline corresponding to a second sub-draft in the a plurality of layers of sub-draft is determined based on a mapping relationship between the timeline corresponding to the target draft and a timeline corresponding to a parent draft of the second sub-draft and a mapping relationship between the timeline corresponding to the parent draft of the second sub-draft and the timeline corresponding to the second sub-draft; wherein the target draft and the second sub-draft are in an indirect nesting relationship.

19. The non-transitory computer-readable storage medium according to claim 16, the processor is further configured to:
determine a playback state of the second material based on the material timestamp corresponding to the target global timestamp in the second material and a material timestamp corresponding to a material frame located before the target material frame in the second material, wherein the playback state comprises at least one selected from the group consisting of a forward playback state, a reverse playback state, a slow-forward state, and a fast-forward state.

20. The non-transitory computer-readable storage medium according to claim 16, wherein before rendering the target frame based on the target material frame, the processor is further configured to:
query a frame drop table, wherein a frame drop moment in the target draft is recorded in the frame drop table; and
drop the target frame when the frame drop table indicates that the target global timestamp belongs to the frame drop moment.
